(19) United States
(12) Patent Application Publication
(10) Pub. No.: US 2010/0234553 A1
(43) Pub. Date: Sep. 16, 2010

(54) Molded Polyurethane Part, Method for its Production and its Use

(75) Inventors: Horst Muehlfeld, Grasellenbach (DE); Thomas Schauber, Hemsbach (DE); Hubert Brueckner, Erkrath (DE); Natalie Bogdanov, Toenisvorst (DE)

Correspondence Address: DeMont & Breyer, LLC, 100 Commons Way, Ste. 250, Holmdel, NJ, 07733, US

(73) Assignee: JOHNSON CONTROLS INTERIORS GMBH & CO. KG, Grefrath (DE)

(21) Appl. No.: 12/293,679

(22) PCT Filed: Mar. 3, 2007
(86) PCT No.: PCT/EP2007/001842

§ 371 Date: Mar. 29, 2010

(30) Foreign Application Priority Data
Apr. 6, 2006 (DE) 10 2006 016 617.5

(51) Int. Cl. C08G 18/78; B29C 39/02; B29C 45/00

(52) U.S. Cl. 528/67; 264/299; 264/328.1

(57) ABSTRACT

The present invention relates to lightfast and hydrolytically resistant molded polyurethane parts with excellent strength properties and a high temperature resistance and colorfastness to light at elevated temperatures for sophisticated applications in the sector of automobile interiors, which products are produced from a reaction mixture of aliphatic and/or cycloaliphatic compositions by using a cost-effective reaction injection molding method (RIM) or a casting method that requires only a short mold residence time. To this end, A) a composition composed of A1) an OH-terminated trifunctional prepolymer, A2) a polyol or a polyol combination, A3) at last one di- and/or trifunctional chain-lengthening agent and/or crosslinking agent with amine and/or hydroxyl groups, and A4) a catalyst system, and optionally A5) a stabilizer system, and optionally A6) at least one additive, and B) an isocyanate composition, are reacted.

### TECHNICAL FIELD

The subject matter of the present invention relates to molded polyurethane parts as well as their production and their use. These molded polyurethane parts are to be used in particular as a surface material, especially for sheeting materials for use as surface covering of structural components for use in the sector of automobile interiors.

Molded polyurethane parts can be produced from a polyurethane system as a reactive mixture in open or closed molds using a casting method or a reaction injection molding (RIM) method.

To ensure a cost-effective method with increased productivity and low production costs, it is especially important to ensure that the mold residence times are as short as possible.

Mold residence time is defined as the time required for a material composition to reach an initial strength sufficient to ensure good demolding properties and an easy removal from an injection mold or a casting mold without deformation and tearing of the product.

### PRIOR ART

To decrease the mold residence time in the production of polyurethanes, the U.S. Pat. Nos. 4,150,206 and 4,292,411 describe special catalytic systems which substantially consist of a combination of an amine initiator and a lead or bismuth catalyst. The special catalytic systems are described for a number of different integral skin foams and elastomers, with the mold residence times in the examples cited being within a range of several minutes.

The printed documents EP-A 0 690 085 and U.S. Pat. No. 5,502,147 describe polyurethane systems which, instead of being based on isophorone diisocyanate (IPDI), are based on comparatively reactive hexamethylene diisocyanate (HDI), the use of which leads to systems which, according to the examples in the printed document U.S. Pat. No. 4,772,639, require mold residence times from 3 to 10 minutes.

The European Patent EP 0 929 586 B1 discloses polyurethane elastomers which, using the RIM method based on the isocyanate component IPDI, can be processed into molded polyurethane in an economically acceptable mold residence time and which are suitable for use in window framing. These polyurethane elastomers can be produced within relatively low mold residence times.

The mechanical properties and the light and temperature stability of known polyurethane systems, however, are frequently inadequate for use in the sector of automobile interiors.

The requirements of the automobile industry that must be met by a surface material for use in the sector of automobile interiors, in particular for sheeting materials for use as surface covering of structural components, are high material strengths, in particular high tensile strength and resistance to tear propagation, and high abrasion resistance. In addition, the feel, in particular a dry and leatherlike hand, and a high light and temperature resistance are criteria that must be met for use in the sector of automobile interiors. During aging tests in which the parts are exposed to hot light at 120° C. and sun simulation over several months, for example, the color, the degree of gloss and the appearance of the grain of the surface should not change. It is especially undesirable if the gloss of the grain structure increases after the special aging process.

### PRESENTATION OF THE INVENTION

Using the prior art as a starting point, the problem to be solved by the present invention is to make available a method for producing molded polyurethane parts which is especially cost-effective, which requires short mold residence times, and which makes it possible to produce molded polyurethane parts that are marked by high mechanical strength and high temperature and light stability. These molded polyurethane parts are to be used especially as a surface material, in particular as a sheeting material for use as surface covering of structural components, in the sector of automobile interiors.

This problem is solved according to the present invention in that
A) a composition composed of the following components:
A1) an OH-terminated trifunctional prepolymer formed from
i) polyol or a polyol combination, in particular with a molar mass from 650 to 4000 and
ii) a trimer based on hexamethylene diisocyanate (HDI) and/or a trimer based on hexamethylene diisocyanate (HDI) with biuret structure, in particular in a molar ratio of polyol (combination) to isocyanate of 3:1,
A2) a polyol or a polyol combination, in particular with a molar mass from 650 to 4000,
A3) at least one di- and/or trifunctional chain-lengthening agent and/or crosslinking agent with NH, NH₂ and/or OH groups and
A4) a catalyst system of at least one organometal compound in combination with at least one amine catalyst and optionally
A5) a stabilizer system and optionally
A6) at least one additive
   and
B) an isocyanate composition composed of:
i) 10 to 90 wt % of isophorone diisocyanate (IPDI) and/or methylene-bis(4-isocyanatocyclohexane) (H₁₂ MDI) and
ii) 10 to 90 wt % of a trimer based on hexamethylene diisocyanate (HDI) with biuret structure and/or a trimer based on hexamethylene diisocyanate (HDI) are reacted in a casting method or in a reaction injection molding method to form an aliphatic and/or cycloaliphatic molded polyurethane part.

To produce the light-resistant molded polyurethane part or system, preferably aliphatic and/or cycloaliphatic polyurethane components are used since aromatic components in the polyurethane system lead to changes in color and to yellowing of the products when these products are exposed to light. Surprisingly, in spite of using aliphatic and/or cycloaliphatic isocyanates, the polyurethanes according to the present invention are marked by especially good strength properties, although the mechanical properties of polyurethanes based on aliphatic and/or cycloaliphatic isocyanates are normally markedly inferior to the mechanical properties of polyurethanes that are based on aromatic isocyanates.

In addition, in spite of the use of aliphatic and/or cycloaliphatic isocyanates which are invariably less reactive than aromatic isocyanates, the mold residence times are very short.

The special combination, preferably of IPDI and/or H₁₂ MDI (Bi) with a trimer based on HDI with biuret structure and a molar mass of 478 and/or a trimer based on HDI with a molar mass of 504 (Bii), reacted with an OH-terminated trifunctional prepolymer (A1) which is produced based on polyether polyol and/or polyester polyol (A1i)) with a trimer based on HDI with biuret structure and/or a trimer based on HDI (A1 ii)), as well as chain lengthening and crosslinkage with amine and OH components (A3), leads to molded parts with especially high strength properties, a high heat stability and mold residence times equal to or less than 60 sec.

Preferably, isophorone diisocyanate (IPDI) and methylene-bis(4-isocyanatocyclohexane (H₁₂ MDI) can be alternatively used as component Bi).

Preferably, a trimer based on HDI and a trimer based on HDI with biuret structure can be alternatively used as component Bii) and A1ii), respectively.

For the prepolymers A1 and the isocyanate composition B, the use of a trimer based on hexamethylene diisocyanate (HDI) with a molar mass of 504 is to be especially preferred.

In a useful embodiment,
A1) 20 to 85 wt % of the prepolymer, relative to the weight of the overall composition A,
A2) 10 to 70 wt % of polyol or the polyol combination, relative to the weight of the overall composition A,
A3) 5 to 20 wt % of the chain-lengthening agent and/or crosslinking agent, relative to the weight of the overall composition A,
A4) 0.01 to 3.5 wt % of the catalyst system, relative to the weight of the overall composition A and/or
A5) 0.2 to 1.5 wt % of the stabilizer system, relative to the weight of the overall composition A,
   are used.

The isocyanate composition B has an NCO content especially between 25 and 35 wt % and preferably comprises
Bi) 40 to 80 wt %, in particular 50 to 75 wt %, of IPDI and/or of H₁₂ MDI, relative to the weight of the overall isocyanate composition B and
Bii) 20 to 60 wt %, in particular 25 to 50 wt %, of the trimer based on HDI with biuret structure and/or the trimer based on HDI, relative to the weight of the overall isocyanate composition B, in particular in a weight ratio of Bi):Bii) of 2:1, preferably of 2:1 to 1.25:1.

As polyol alone or as polyol combination (A1i) and/or A2), preferably one is selected from the group consisting of
polypropylene ether polyol, in particular with a molar mass from 800 to 2000,
a copolymer of polycaprolactone (PCL) and polytetrahydrofuran (PTHF), in particular with a molar mass from 2000 to 4000,
polytetrahydrofuran, in particular with a molar mass from 650 to 3000,
polycarbonate diol, in particular with a molar mass from 1000 to 2000, and/or
polyadipate based on butanediol, hexanediol and/or neopentyl glycol, in particular with a molar mass from 1000 to 2000, is used.

For a long-chain soft segment structure, stable mixtures for the reaction with isocyanate are preferably also obtained with the further addition of di- and/or trifunctional polyols based on polyether and/or polyester.

In a preferred embodiment, to ensure a rapid cure and short mold residence times, the fundamental building blocks of the polyurethanes required can be produced by means of a pre-reaction of the special OH-terminated trifunctional prepolymer (A1) by reacting the trimer based on HDI with the polyols and polyol combinations described above.

The addition of polyol or polyol combinations (A2) to composition A has an influence mainly on the hardness of the polyurethane system and the molded polyurethane part, with the use of polyol with functionality 2 being preferred to obtain a linear structure and a superior crystallization of the reaction products. Polypropylene ether polyol with a molar mass of 1000 and 2000, PCL-PTHF copolymer with a molar mass of 2000, polytetrahydrofuran with a molar mass of 2000 and neopentyl glycol adipate with a molar mass of 2000 have been found to be especially suitable.

For reasons of the low viscosity, polyol combinations (A2), preferably selected from two polyols of the group of polypropylene ether polyol, PCL-PTHF copolymer and neopentyl glycol adipate, are used in the production of molded polyurethane parts to ensure good processing and good compatibility with the other amine and hydroxyl groups of the chain-lengthening agents and/or crosslinking agents.

Especially useful for the polyol combinations (A1i) and/or A2) is the use of the PCL-PTHF copolymer which, as a phase mediator, ensures superior homogenization and is suitable for use in combination with the polyether and polyester polyols of a different structure to produce a mixture that is stable in storage.

In an especially useful embodiment, the same polyol combinations are used both as component A1i) and as component A2.

To ensure an especially short mold residence time and especially high tensile strength, elongation at break and resistance to tear propagation, an especially preferred embodiment provides for the use of polypropylene ether polyol, in particular with a molar mass of 2000, an OH value of 54 and a propylene oxide (PO) content of 100%, and a PCL-PTHF copolymer, in particular with a molar mass of 2000 and an OH value of 58, as components A1i) and A2, respectively.

To ensure an especially short mold residence time and high tensile strength, elongation at break and resistance to tear propagation, it is recommended that polypropylene ether polyol, in particular with a molar mass of 2000, an OH value of 54 and a PO content of 100%, and polytetrahydrofuran (PTHF), in particular with a molar mass of 2000 and an OH value of 56, be used as components A1i) and A2, respectively.

To ensure a short mold residence time and an especially high tensile strength, elongation at break and resistance to tear propagation, a PCL-PTHF copolymer, in particular with a molar mass of 2000 and an OH value of 58, and neopentyl glycol adipate, in particular with a molar mass of 2000 and an OH value of 55, are preferably used as components A1i) and A2, respectively.

The chain-lengthening agents and/or crosslinking agents (A3) used are preferably those selected from the group consisting of butanediol, hexanediol, trimethylolpropane, ethanolamine, diethanolamine, ethylenediamine and/or hexamethylenediamine, alone or in combination with one another, with a molar mass of 60 to 250.

The amine groups have a marked influence on the reactivity of the polyurethane. In the reaction with isocyanate, high quantities in the system of crosslinking agents lead to an excessively rapid jelling of the mixture, with the disadvantage that molds with deep flows cannot be completely filled.

As a result, combinations of hydroxyl and amine groups are preferably used. The content of components with amine groups is preferably within a range from 1 to 40 wt % relative to the sum of the chain-lengthening agents and crosslinking agents.

The catalyst system (A4) preferably used is one selected from the group consisting of organometal compounds, such as bismuth, tin, zirconium and/or potassium compounds, in combination with amine catalysts, in particular triethylenediamine and/or dimethylaminopropyl urea.

The stabilizer system (A5) preferably used is one selected from the group consisting of antioxidants, UV absorbers and/or light stabilizers.

To ensure good resistance to degradation by light, oxygen and heat, the stabilizer system (A5) preferably added comprises antioxidants and UV absorbers in combination with light stabilizers. The antioxidants preferred are those of the substituted phenol and/or aliphatic or aromatic organophosphite type, the light stabilizers preferred are those of the substituted alicyclic amine type and the UV absorbers preferred are those of the benzotriazole type.

Optionally, additives (A6), in particular water-absorbing agents, for example, zeolites, antiblocking agents and/or internal mold release agents, can be added to composition A.

Compositions A and B preferably have an NCO index between 95 and 115 and are preferably processed at a temperature from 40° C. to 60° C. and cast or injected into a mold preheated to a temperature between 60° C. and 120° C., in particular between 80° C. and 100° C.,

In addition, the problem to be solved by the present invention, which is to make available molded polyurethane parts which are marked by a high temperature and light stability and which can be prepared especially cost-effectively while ensuring short mold residence times, is solved by the features of claim 10.

The molded polyurethane parts described above are preferably used in the form of sheeting materials, in particular as a surface covering of structural components, especially in the sector of automobile interiors.

In addition, the present invention also relates to a polyurethane system which comprises a composition A and a composition B, with the composition A being composed of the following components:
A1) an OH-terminated trifunctional prepolymer formed from
i) polyol or a polyol combination, in particular with a molar mass of 650 to 4000 and in particular with an OH value of 100 to 500, and
ii) a trimer based on hexamethylene diisocyanate (HDI) and/or a trimer based on hexamethylene diisocyanate (HDI) with biuret structure, in particular in a molar ratio of the polyol (combination) to the isocyanate of 3:1,
A2) a polyol or a polyol combination, in particular with a molar mass of 650 to 4000,
A3) at least one di- and/or trifunctional chain lengthening agent and/or crosslinking agent with NH, NH₂ and/or OH groups, and
A4) a catalyst system of at least one organometal compound in combination with at least one amine catalyst and optionally
A5) a stabilizer system and optionally
A6) at least one additive, and with the isocyanate composition B composed of the following components:
i) 10 to 90 wt % of isophorone diisocyanate (IPDI) and/or methylene-bis(4-isocyanatocyclohexane) (H₁₂ MDI) and
ii) 10 to 90 wt % of a trimer based on hexamethylene diisocyanate (HDI) with biuret structure and/or a trimer based on hexamethylene diisocyanate (HDI).

The preferred embodiments have the above-mentioned specifications of the compositions A and B.

The polyurethane system mentioned preferably has a tensile strength according to DIN/ISO 527-3 greater than 10 MPa, preferably greater than 15 MPa, and/or an elongation at break according to DIN/ISO 527-3 greater than 170%, preferably greater than 190%, and/or a resistance to tear propagation according to DIN/ISO 13937 greater than 5 N/mm, preferably greater than 7 N/mm.

Polyurethane systems of this type can be used to advantage to produce molded parts, nonwoven fabrics or sheeting materials for use in hygienic and medical applications.

With the molded polyurethane parts and polyurethane systems according to the present invention, high values especially with respect to tensile strength, resistance to tear propagation and abrasion resistance are obtained. In tests investigating the aging behavior from exposure to heat and hot light at 120° C. carried out according to the requirements of the automobile industry on RIM sheeting materials, no changes in the grain structure of the surface were found. In addition, it was also not possible to observe an increase in the gloss of the surface.

### MEANS OF CARRYING OUT THE INVENTION

Especially preferred practical examples of the present invention will be described below. To produce test sheeting materials, two reactive compositions A and B were produced:

### Composition A:

A1) OH-terminated prepolymer formed from a polyol (combination) and a trimer based on HDI
A2) a polyol (combination)
A3) chain lengthening agents and crosslinking agents
A4) a catalyst system
A5) a stabilizer system

### Composition B:

Bi) IPDI or H₁₂ MDI
Bii) a trimer based on HDI or a trimer based on HDI with biuret structure
IPOI: isophorone diisocyanate, molar mass 222, NCO content 37.6% (Vestanat IPDI, Degussa)
H₁₂ MDI: methylene-bis(4-isocyanatocyclohexane) molar mass 262, (Desmodur W, Bayer)
Trimer based on HDI: trimer based on hexamethylene diisocyanate, molar mass 504, NCO content 22%, functionality 3 (Tolonate HDT, Rhodia)
Trimer based on HDI with biuret structure: timer based on hexamethylene diisocyanate with biuret structure, with a molar mass of 478, NCO content 22%, functionality 3 (Tolonate HDB, Rhodia)

For use in the casting method, the compositions A and B are mixed for 5 sec at a temperature of 40° C. in a high-speed stirring apparatus and subsequently cast into an open mold which had been heated to a temperature of 80° C. After 60 sec, the molded sheeting material is removed from the mold and, while still hot, tested for initial strength and hot brittleness by subjection to drawing and lateral bending tests.

For use in the RIM (reaction injection molding) method, the compositions A and B are mixed at a temperature of 60° C. in a high-pressure system using a high-pressure mixer and injected into a closed mold which had been heated to a temperature of 100° C. After 50 sec, the molded sheeting material is tested for initial strength in a manner identical to that used in the casting method.

The compositions A and B listed in the following tables were reacted in the casting method.

TABLE 1
Prepolymers (A1) that were used in the examples

| | | A1i) | A1ii) | Viscosity | |
|---|---|---|---|---|---|
| A1) | A1i) | Polyol | Trimer based on HDI | at 40° C. | OH value |
| Prepolymer | Polyol | (parts by weight) | (parts by weight) | (mPa) | measured |
| Prepolymer 1 | Polypropylene | 100.00 | 16.80 | 4800 | 31 |
| | ether polyol | | | | |
| | (OH value 110) | | | | |
| Prepolymer 2 | Polypropylene | 60.00 | 8.40 | 3200 | 16 |
| | ether polyol | | | | |
| | (OH value 54) | | | | |
| | PCL-PTHF | 40.00 | | | |
| | copolymer (OH | | | | |
| | value 58) | | | | |
| Prepolymer 3 | Polypropylene | 50.00 | 8.40 | 3650 | 17 |
| | ether polyol | | | | |
| | (OH value 54) | | | | |
| | PTHF (OH | 50.00 | | | |
| | value 56) | | | | |
| Prepolymer 4 | PCL-PTHF | 50.00 | 8.40 | 5300 | 16 |
| | copolymer (OH | | | | |
| | value 58) | | | | |
| | Neopentyl | 50.00 | | | |
| | glycol adipate | | | | |
| | (OH value 55) | | | | |

Production of the trifunctional and OH-terminated prepolymers (A1):

While stirring, the polyol or the polyols and the trimer based on HDI were reacted in a reactor for 3 h at a temperature of 80° C.
Polyol 1 (A1i), A2): Polypropylene ether polyol, molar mass 1000, OH value 110, propylene oxide (PO) content 100%, (Desmophen 1110, Bayer)
Polyol 2 (A1i), A2): Polypropylene ether polyol, molar mass 2000, OH value 54, PO content 100%, (Desmophen 3600, Bayer)
Polyol 3 (A1i), A2): Polycaprolactone (PCL)-polytetrahydrofuran (PTHF) copolymer, molar mass 2000, OH value 58, PO content 100%, (Capa 7201, Interox)
Polyol 4 (A1i), A2): Polytetrahydrofuran, molar mass 2000, OH value 56, (PTHF, BASF)
Polyol 5 (A1i), A2): Neopentyl glycol adipate, molar mass 2000, OH value 55, (Desmophen 2028, Bayer)

TABLE 2
Isocyanate composition B, which was used in the examples

| | | | | Bii) | |
|---|---|---|---|---|---|
| | Bi) | Bi) | Bii) | Trimer based on HDI | NCO |
| | IPDI | H₁₂ MDI | Trimer based on HDI | with biuret structure | content |
| B | (parts by weight) | (parts by weight) | (parts by weight) | (parts by weight) | (%) |
| ISO 1 | 100.00 | — | 50.00 | | 32.2 |
| ISO 2 | 100.00 | — | 80.00 | | 30.1 |
| ISO 3 | — | 100.00 | 40.00 | | 28.4 |
| ISO 4 | 100.00 | — | — | 65.00 | 31.1 |

TABLE 3
Examples

| | Example 1 | Example 2 | Example 3 | Example 4 | Example 5 |
|---|---|---|---|---|---|
| | Parts by weight | Parts by weight | Parts by weight | Parts by weight | Parts by weight |
| A1) Prepolymer 1 | 40.0 | | | | |
| Prepolymer 2 | | 50.0 | | | 60.0 |
| Prepolymer 3 | | | 35.0 | | |
| Prepolymer 4 | | | | 25.0 | |
| A2) Polyol 1 | 20.0 | | | | |
| Polyol 2 | | 20.0 | 30.0 | | 18.0 |
| Polyol 3 | 26.00 | 17.0 | | 40.0 | 11.0 |
| Polyol 4 | | | 20.0 | | |
| Polyol 5 | | | | 23.0 | |
| A3) Chain-lengthening agent/ | | | | | |
| crosslinking agent | | | | | |
| 1,4-Butanediol | 10.0 | | 6.0 | 6.0 | 6.0 |
| 1,6-Hexanediol | | 8.0 | | | |
| Trimethylolpropane | | | 3.0 | 2.0 | |
| Ethanolamine | | | | 4.0 | 5.0 |
| Diethanolamine | 4.0 | 5.0 | 6.0 | | |
| A4) Catalyst system | | | | | |
| Bismuth neodecanoate | 0.30 | 0.35 | 0.30 | 0.35 | 0.35 |
| Dimethylaminopropyl urea | 0.15 | 0.15 | 0.10 | 0.20 | 0.20 |
| A5) Stabilizer system | | | | | |
| Tinuvin 213 and | 0.25 | 0.25 | 0.25 | 0.25 | 0.25 |
| Tinuvin 123 and | | | | | |
| Irganox 245 | | | | | |
| B) Isocyanate composition | | | | | |
| ISO 1 | 58.2 | | 59.1 | | |
| ISO 2 | | 48.5 | | | |
| ISO 3 | | | | 58.8 | |
| ISO 4 | | | | | 49.1 |

Stabilizer system (A5):

### Antioxidant: Irganox 245 (Ciba)

UV absorber: Tinuvin 213 (Ciba)
Light stabilizer: HALS: Tinuvin 123 (Ciba)

TABLE 4
Comparative examples (prior art)

| | Example 6 | Example 7 |
|---|---|---|
| | Parts by weight | Parts by weight |
| Polyether triol (propylene oxide and | 90.0 | |
| ethylene oxide content) | | |
| Molar mass 4800, OH value 35, | | |
| 85% primary OH groups, 15% EO | | |
| Quasi-prepolymer polyol: | | 85.0 |
| Polyether diol, molar mass 2000, OH | | |
| value 56, 100% PO and IPDI, | | |
| 100/2.5, measured OH value: 44 | | |
| Ethylene glycol | 7.0 | 7.0 |
| Diethanolamine | 3.5 | 6.0 |
| Lead 2-ethyl hexoate | 0.5 | 0.5 |
| Dimethyltin dineodecanoate | 0.25 | 0.25 |
| UV stabilizer | 6.0 | 6.0 |
| IPDI/IDPI trimer (48/52), 28% NCO | 60.9 | |
| H₁₂ MDI/IPDI trimer (40/60), 24% | | 95.9 |
| NCO | | |

TABLE 5
Reactivity and physical properties

| | | | | | | Example 6 | Example 7 |
|---|---|---|---|---|---|---|---|
| | Example 1 | Example 2 | Example 3 | Example 4 | Example 5 | (prior art) | (prior art) |
| Properties | Parts by weight | Parts by weight | Parts by weight | Parts by weight | Parts by weight | Parts by weight | Parts by weight |
| Gel time (seconds) | 5 | 5 | 5 | 5 | 5 | 7 | 5 |
| Mold residence | 60 | 50 | 50 | 60 | 60 | 180 | 140 |
| time (seconds) | | | | | | | |
| Tensile strength | 16 | 18 | 15 | 19 | 18 | 7 | 9 |
| (MPa) DIN/ISO | | | | | | | |
| 527-3 | | | | | | | |
| Elongation at | 190 | 225 | 205 | 265 | 220 | 130 | 170 |
| break (%) DIN/ISO | | | | | | | |
| 527-3 | | | | | | | |
| Resistance to | 8 | 12 | 7 | 11 | 12 | 4 | 5 |
| tear propagation | | | | | | | |
| (N/mm) DIN/ISO | | | | | | | |
| 13937 | | | | | | | |
| Scratch resistance | No writing | No writing | No writing | No writing | No writing | Strong | Weak |
| Fingernail test | mark | mark | mark | mark | mark | writing mark | writing mark |
| Heat resistance | No gloss, | No gloss, | No gloss, | No gloss, | No gloss, | High gloss, | Low gloss, |
| 3 d/120° C. | no tackiness | no tackiness | no tackiness | no tackiness | no tackiness | low tackiness | low tackiness |
| Color-fastness to | No change in | No change in | No change in | No change in | No change in | High gloss, no | High gloss, no |
| light at elevated | gloss and color | gloss and color | gloss and color | gloss and color | gloss and color | change in color | change in color |
| temperature VDA | | | | | | | |
| 75202 Gray scale | | | | | | | |

In the comparative examples according to the prior art (Examples 6 and 7), markedly longer mold residence times, markedly lower strength properties, and a lower resistance to heat and colorfastness to light at elevated temperatures were measured as compared to those of the molded polyurethane parts according to the present invention.

In one embodiment of the molded polyurethane part with polypropylene ether polyol and PCL-PTHF copolymer as component A1i) and A2 and with IPDI (Bi)) and a trimer based on HDI (Bii)) as isocyanate composition B and a trimer based on HDI as component A1ii) for the prepolymer, the mold residence time is especially short, and the tensile strength, the elongation at break and the resistance to tear propagation are especially high.

In another embodiment of the molded polyurethane part with polypropylene ether polyol and polytetrahydrofuran (PTHF) as component A1i) and A2 and with IPDI (Bi)) and a trimer based on HDI (Bii)) as isocyanate composition B and a trimer based on HDI as component A1ii) for the prepolymer, the mold residence time is especially short and the tensile strength, the elongation at break and the resistance to tear propagation are high.

In yet another embodiment of the molded polyurethane part with PCL-PTHF copolymer and neopentyl glycol adipate as component A1i) and A2 and with H₁₂ MDI (Bi)) and a trimer based on HDI (Bii)) as isocyanate composition B and a trimer based on HDI as component A1ii) for the prepolymer, the mold residence time is low and the tensile strength, the elongation at break and the resistance to tear propagation are especially high.

In yet another embodiment of the molded polyurethane part with polypropylene ether polyol and PCL-PTHF copolymer as component A1i) and A2 and with IPDI (Bi)) and a trimer based on HDI with biuret structure (Bii) as isocyanate composition B and a trimer based on HDI as component A1i)) for the prepolymer, the mold residence time is low and the tensile strength, the elongation at break and the resistance to tear propagation are especially high.

Using polyurethane systems in which the polyol component is reacted only with H₁₂ MDI or IPDI or in combination with the relevant trimer, it was not possible to achieve either the special property profile of the molded polyurethane parts according to the present invention, such as high mechanical strength and high temperature resistance and fastness to light, or the cost-effective production of such parts at short mold residence times.

In addition, the evaluation of the mechanical properties and the colorfastness to light at elevated temperatures also revealed marked disadvantages of the comparison mixtures. With the prior-art sheeting materials produced, especially the tensile strength and the resistance to tear propagation reached values of only 50% to 60% of those obtained with the reaction systems according to the present invention.

Aging the sheeting materials of the comparison mixtures by exposure to hot light at 120° C. led to a pronounced increase in the gloss of the surface while no changes in the degree of gloss and in the grain stability were observed in the sheeting materials according to the present invention.

1. A method for producing an aliphatic and/or cycloaliphatic molded polyurethane part in a casting method or a reaction injection molding method, the method comprising reacting:
A) a composition composed of
A1) an OH-terminated trifunctional prepolymer formed from
i) polyol or a combination of polyol, and
ii) a trimer based on hexamethylene diisocyanate (HDI) and/or a trimer based on hexamethylene diisocyanate (HDI) with biuret structure,
A2) a polyol or a polyol combination,
A3) at last one di- and/or trifunctional chain-lengthening agent and/or crosslinking agent with amine and/or hydroxyl groups and
A4) a catalyst system of at least one organometal compound in combination with at least one amine catalyst and optionally
A5) a stabilizer system and optionally
A6) at least one additive and
B) an isocyanate composition composed of
i) 10 to 90 wt % of isophorone diisocyanate (IPDI) and/or methylene-bis(4-isocyanatocyclohexane) (H₁₂ MDI) and
ii) 10 to 90 wt % of a trimer based on hexamethylene diisocyanate (HDI) with biuret structure and/or a trimer based on hexamethylene diisocyanate (HDI).

2. The method as claimed in claim 1, wherein
20 to 85 wt % of the prepolymer, relative to the weight of the overall composition A,
10 to 70 wt % of the polyol or the polyol combination, relative to the weight of the overall composition A,
5 to 20 wt % of the chain-lengthening agent and/or crosslinking agent, relative to the weight of the overall composition A,
0.01 to 3.5 wt % of the catalyst system, relative to the weight of the overall composition A and/or
0.2 to 1.5 wt % of the stabilizer system, relative to the weight of the overall composition A, are used.

3. The method as in claim 1, wherein the isocyanate composition used is composed of
i) 40 to 80 wt % of IPDI and/or of H₁₂ MDI, relative to the weight of the overall isocyanate composition B, and
ii) 20 to 60 wt % of the trimer based on HDI with biuret structure and/or the trimer based on HDI, relative to the weight of the overall isocyanate composition B.

4. The method as claimed in claim 1, wherein the polyol or the polyol combination is selected from the group consisting of polypropylene ether polyol, copolymer of polycaprolactone (PCL) and polytetrahydrofuran (PTHF), polytetrahydrofuran, polycarbonate diol and/or polyadipate based on butanediol, hexanediol and/or neopentyl glycol with a molar mass of 650 to 4000.

5. The method as in claim 1, wherein the chain-lengthening agent and/or crosslinking agent is selected from the group consisting of butanediol, hexanediol, trimethylol propane, ethanolamine, diethanolamine, ethylenediamine and/or hexamethylenediamine with a molar mass of 60 to 250.

6. The method as in claim 1, wherein the catalyst system is selected from the group consisting of organometal compounds in combination with amine catalysts.

7. The method as in claim 1, wherein the stabilizer system is selected from the group consisting of antioxidants, UV absorbers and/or light stabilizers.

8. The method as in claim 1, wherein the at least one additive is water-absorbing agents, antiblocking agents and/or internal mold release agents.

9. The method as in claim 1, wherein the compositions A and B with an NCO index between 95 and 115 are processed at a temperature between 40° C. and 60° C. and subsequently cast or injected into a mold that has been heated to a temperature between 60° C. and 120° C.

10. A molded polyurethane part produced in accordance with a method as in claim 1.

11. The molded polyurethane part as in claim 10 which has a mold residence time shorter than or equal to 60 sec, and a tensile strength according to DIN/ISO 527-3 greater than 10 MPa and/or an elongation at break according to DIN/ISO 527-3 greater than 170% and/or a resistance to tear propagation according to DIN/ISO 13937 greater than 5 N/mm.

12. A method for providing a sheeting material, the method comprising utilizing the molded polyurethane part as in claim 10.

13. A polyurethane system comprising the compositions A and B as in claim 1.

14. The polyurethane system as in claim 13 which has a mold residence time shorter than or equal to 60 sec and a tensile strength according to DIN/ISO 527-3 greater than 10 MPa and/or an elongation at break according to DIN/ISO 527-3 greater than 170% and/or a resistance to tear propagation according to DIN/ISO 13937 greater than 5 N/mm.

15. A method for producing molded parts, nonwoven fabrics or sheeting materials for hygienic and medical applications, the method comprising utilizing the polyurethane system as in claim 13.
